(19) United States
(12) Patent Application Publication
(10) Pub. No.: US 2015/0271083 A1
(43) Pub. Date: Sep. 24, 2015

(54) TECHNIQUES FOR WINDOW SIZE CONFIGURATION

(71) Applicant: QUALCOMM Incorporated, San Diego, CA (US)

(72) Inventors: Sitaramanjaneyulu KANAMARLAPUDI, San Diego, CA (US); Chetan Gopalakrishnan CHAKRAVARTHY, San Diego, CA (US); Yongsheng SHI, San Diego, CA (US); Vagish GUPTA, Hyderabad (IN)

(21) Appl. No.: 14/514,121

(22) Filed: Oct. 14, 2014

Related U.S. Application Data
(60) Provisional application No. 61/969,580, filed on Mar. 24, 2014.

(51) Int. Cl. H04L 12/807; H04W 24/04; H04W 72/04

(52) U.S. Cl. CPC H04L 47/27; H04W 72/0453; H04W 24/04

(57) ABSTRACT

Techniques for configuring a window size are described. A user equipment (UE) may identify a first window size for communications between the UE and a source network and determine that the first window size is invalid for a target configuration of communications between the UE and a target network. When the first window size is invalid for the target configuration, the UE may calculate a second window size for the target configuration of communications between the UE and the target network based on one or more parameters of the target configuration. The calculation of the second window size may be based on one or more parameters of the target configuration. Moreover, the one or more parameters may at least include a stored window size from a previous configuration of the communications between the UE and the source network.

### CLAIM OF PRIORITY

This application claims the benefit of and priority to commonly owned U.S. Provisional Patent Application No. 61/969,580, filed Mar. 24, 2014, and assigned Attorney Docket No. 144116P1, the disclosure of which is hereby incorporated by reference herein.

### BACKGROUND

The described aspects relate generally to wireless communication systems. More particularly, the described aspects relate to techniques for window size configuration.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks. Furthermore, UMTS supports multiple radio access bearer (multi-RAB) capability, which allows simultaneous network communication with a user equipment (UE) over two or more radio access bearers. Therefore, in an aspect, multi-RAB functionality in UMTS allows for a UE to concurrently transmit and receive packet-switched (PS) and circuit-switched (CS) data.

A UE may operate in communication with a network that supports one or more carriers, e.g., single carrier (SC), dual carriers (DC), three carriers (3C), four carriers (4C), five carriers (5C), etc. When the UE operates in communication with a SC or DC network in High Speed Downlink Packet Access (HSDPA), the length of a Transmission Sequence Number (TSN) may determine an enhanced high speed medium access control (MAC-ehs) window size, which may indicate a maximum amount of data packets that may be received by the UE within a time period. For example, when the maximum length of the TSN is 6 bits, the maximum MAC-ehs window size is correspondingly determined as 32. Unlike a SC or DC network, the length of the TSN may be up to 14 bits in a network that supports more than two carriers and the maximum MAC-ehs window size may be 128. As such, when the UE moves from a network that supports more than two carriers, e.g., 3C/4C/5C, to a SC or DC network, the MAC-ehs window size for the 3C/4C/5C network may not be valid for or supported by the SC or DC network.

Therefore, there is a desire for techniques for window size configuration when the UE moves from a network that supports more than two carriers, e.g., 3C/4C/5C, to a SC or DC network.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The present disclosure presents examples of techniques for configuring a window size. An example method may include identifying a first window size for communications between a user equipment (UE) and a source network. In addition, the example method may include determining that the first window size is invalid for a target configuration of communications between the UE and a target network. Further, the example method may include calculating a second window size for the target configuration of communications between the UE and the target network, wherein the calculating is based on one or more parameters of the target configuration when a determination is made that the first window size is invalid in the target configuration, and wherein the one or more parameters at least include a stored window size from a previous configuration of the communications between the UE and the source network.

An example apparatus for configuring a window size may include means for identifying a first window size for communications between a UE and a source network. In addition, the example apparatus may include means for determining that the first window size is invalid for a target configuration of communications between the UE and a target network. Further, the example apparatus may include means for calculating a second window size for the target configuration of communications between the UE and the target network, wherein the means for calculating is based on one or more parameters of the target configuration when a determination is made that the first window size is invalid in the target configuration, and wherein the one or more parameters at least include a stored window size from a previous configuration of the communications between the UE and the source network.

Another example apparatus for configuring a window size may include a window size identifier configured to identify a first window size for communications between a UE and a source network. The example apparatus may additionally include a window size verifier configured to determine that the first window size is invalid for a target configuration of communications between the UE and a target network. Further, the example apparatus may include a window size calculator configured to calculate a second window size for the target configuration of communications between the UE and the target network, wherein the window size calculator calculates the second window size based on one or more parameters of the target configuration when a determination is made that the first window size is invalid in the target configuration, and wherein the one or more parameters at least include a stored window size from a previous configuration of the communications between the UE and the source network.

A computer-readable medium storing computer executable code for configuring a window size may include code for identifying a first window size for communications between a UE and a source network. Additionally, the computer-readable medium may include code for determining that the first window size is invalid for a target configuration of communications between the UE and a target network. Further, the computer-readable medium may include code for calculating a second window size for the target configuration of communications between the UE and the target network, wherein the code for calculating is based on one or more parameters of the target configuration when a determination is made that the first window size is invalid in the target configuration, and wherein the one or more parameters at least include a stored window size from a previous configuration of the communications between the UE and the source network.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram illustrating a wireless communication system in which a user equipment moves from a network that supports more than two carriers to another network that supports SC or DC, having aspects configured to configure a window size;

FIG. 2 is block diagram illustrating components by which the techniques for window size configuration may be implemented;

FIG. 3 is a flow chart of aspects of a method for configuring a window size;

FIG. 4 is a block diagram illustrating an example of a hardware implementation for an apparatus employing a processing system having aspects configured to configure a window size;

FIG. 5 is a block diagram illustrating an example of a telecommunications system having aspects configured to configure a window size;

FIG. 6 is a block diagram illustrating an example of an access network having aspects configured to configure a window size;

FIG. 7 is a block diagram illustrating an example of a radio protocol architecture for user and control planes for window size configuration; and

FIG. 8 is a block diagram illustrating an example of a base station (e.g., Node B) in communication with a UE in a telecommunications system having aspects configured to configure a window size.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

A UE may operate in communication with a network that supports one or more carriers, e.g., SC, DC, 3C, 4C, 5C, etc. When the UE operates in communication with a single carrier (SC) or dual carrier (DC) network in High Speed Downlink Packet Access (HSDPA), a MAC-ehs window size may be determined by the length of a Transmission Sequence Number (TSN). For example, when the maximum length of the TSN is 6 bits, the maximum MAC-ehs window size is correspondingly determined as 32. A MAC-ehs window size of 64 or more may be determined as invalid and thus will not be supported by the SC or DC network. Unlike a SC or DC network, the length of the TSN may be up to 14 bits in a network that supports more than two carriers and the maximum valid MAC-ehs window size may be 128. As such, when the UE moves from a source network that supports more than two carriers, e.g., 3C/4C/5C, to a SC or DC target network, the MAC-ehs window size for the source network may not be valid for or supported by the SC or DC target network. As referenced hereinafter, a network that supports more than two carriers may be referred to as a multiple carrier or multi-carrier (MC) network.

In some aspects, the UE may be configured to calculate another MAC-ehs window size for the SC or DC network when the UE moves from an MC network to a SC or DC network. Such calculation may be performed by the UE based at least on a maximum window size supported by the SC or DC network, e.g., 32, and/or a window size previously stored in the UE when the UE was in earlier communication with the MC network.

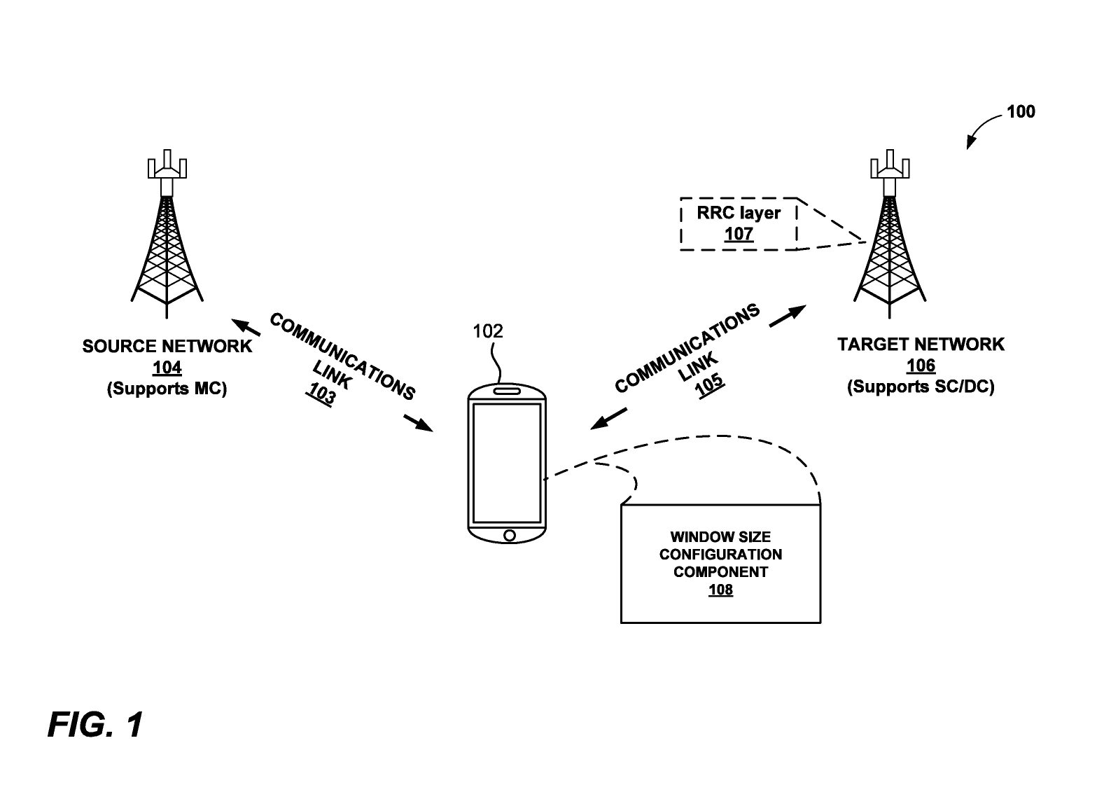

Referring to FIG. 1, a wireless communication system 100 may include a UE 102 having one or more components for window size configuration. In an aspect, the term “component” as used herein may be one of the parts that make up a system, may be implemented as hardware, software, firmware, or any combination thereof, and may be further divided into other components. By operating in communication with a source network 104 that supports more than two carriers in MC HSDPA, UE 102 may be configured to receive data on more than two downlink carriers over communications link 103 from source network 104. When UE 102 is in communication with a target network 106 that supports one or two carriers, UE 102 may be configured to receive data on the one or two carriers over communications link 105 from target network 106.

In some aspects, UE 102 also may be referred to as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

In MC HSDPA, a TSN may be extended to more than 6 bits, e.g., 14 bits, and thus, a length of a MAC-ehs window size may be more than 32, or even more than 128. When UE 102 switches from source network 104 (e.g., MC) to target network 106 (e.g., SC/DC), a radio resource control (RRC) layer 107 associated with target network 106 may transmit a number of RRC messages over communications link 105 to reconfigure UE 102, e.g., to adjust parameters regarding the communication between UE 102 and target network 106. In some aspects, one or more of the RRC messages may include a MAC-ehs window size (or information indicative of a MAC-ehs window size) for a target configuration of communications between UE 102 of target network 106. As referenced herein, a target configuration may refer to the configuration needed for a UE to perform communications with a target network, e.g., target network 106.

The RRC messages to reconfigure UE 102 may include Physical Channel Reconfiguration (PCRC) messages, Radio Bearer Reconfiguration (RBRC) messages, Transport Channel Reconfiguration (TCRC) messages, Active Set Update (ASU), Radio Bearer Setup (RBS), Radio Bearer Release (RBR), etc. Such RRC messages may be utilized to reconfigure different aspects of communications between UE 102 and target network 106 such as physical channels, radio bearers, transport channels, etc. In some non-limiting examples, RBRC messages, TCRC messages, RBS messages, or RBR messages may optionally include a MAC-ehs window size (or information indicative of a MAC-ehs window size); however, typically PCRC or ASU messages may not include the MAC-ehs window size. Thus, when PCRC messages are transmitted from target network 106 to reconfigure UE 102, or when RBRC or TCRC messages omit a MAC-ehs window size, UE 102 may be configured to calculate a MAC-ehs window size for the target configuration of communications between UE 102 and target network 106 so that the MAC-ehs window size for source network 104 may not be reused by RRC layer 107 for target network 106.

Window size configuration component 108, as a component of UE 102, may refer to a component that may be configured to identify a MAC-ehs window size previously used for communications between UE 102 and source network 104. In addition, window size configuration component 108 may store the MAC-ehs window size for the communications with source network 104 in a memory device (not shown) associated with UE 102.

Further, window size configuration component 108 may be configured to determine that the identified MAC-ehs window size is invalid for the target configuration of communications between UE 102 and target network 106. That is, window size configuration component 108 may detect the number of carriers that target network 106 supports. Based on the detected number of carriers, window size configuration component 108 may determine the maximum valid MAC-ehs window size of the target configuration since the correspondence between the number of carriers and the maximum valid MAC-ehs window size may be specified in communications standards. For example, when window size configuration component 108 detects that target network 106 supports DC, window size configuration component 108 may determine that the maximum valid MAC-ehs window size is 32 per 3GPP 25.331 10.3.5.1c.

When a determination is made that the identified MAC-ehs window size is invalid for the target configuration (e.g., for target network 106), window size configuration component 108 may be configured to calculate another or different MAC-ehs window size for the target configuration of communications between UE 102 and target network 106. Such calculation may be performed based on one or more parameters associated with target network 106 including a maximum window size supported by the target configuration. In some aspects, the parameters may also include a stored MAC-ehs window size from a previous configuration of the communications between UE 102 and source network 104.

Further, such calculation may also be based upon the RRC messages that UE 102 receives to reconfigure UE 102. That is, window size configuration component 108 may determine the type of RRC message received by UE 102 and whether the RRC message includes a MAC-ehs window size for the target configuration. Based on the determination, window size configuration component 108 may then calculate the MAC-ehs window size for the target configuration.

For example, if the RRC message received by UE 102, e.g., a RBRC or TCRC message, to reconfigure UE 102 omits a MAC-ehs window size or the RRC message is a PCRC message that typically does not include a MAC-ehs window size, window size configuration component 108 may be configured to identify the appropriate MAC-ehs window size by selecting a smallest window size from the stored MAC-ehs window size from the previous configuration and the maximum window size supported by the target configuration. Further to the example, when the maximum window size supported by target network 106 is 32 and the stored MAC-ehs window size from the previous configuration is 64 for the previous communications between UE 102 and target network 106, window size configuration component 108 may select 32 as the MAC-ehs window size for the target configuration.

Alternatively, if a PCRC message is received by UE 102 for the target configuration and the stored MAC-ehs window size from the previous configuration is not supported in the target configuration, UE 102 may be configured to reject the configuration. That is, in a non-limiting example, UE 102 may be configured to send a failure message to target network 106 to indicate the invalidity of the stored MAC-ehs window size in the target configuration. UE 102 may then revert to source network 104 to continue the communications with source network 104 with the stored MAC-ehs window size from the previous configuration. In another example, if a RBRC message or a TCRC message received by the UE for the target configuration omits a value indicating a MAC-ehs window size, UE 102 may also be configured to reject the configuration. That is, UE 102 may send a failure message to target network 106 and continue the communications with source network 104.

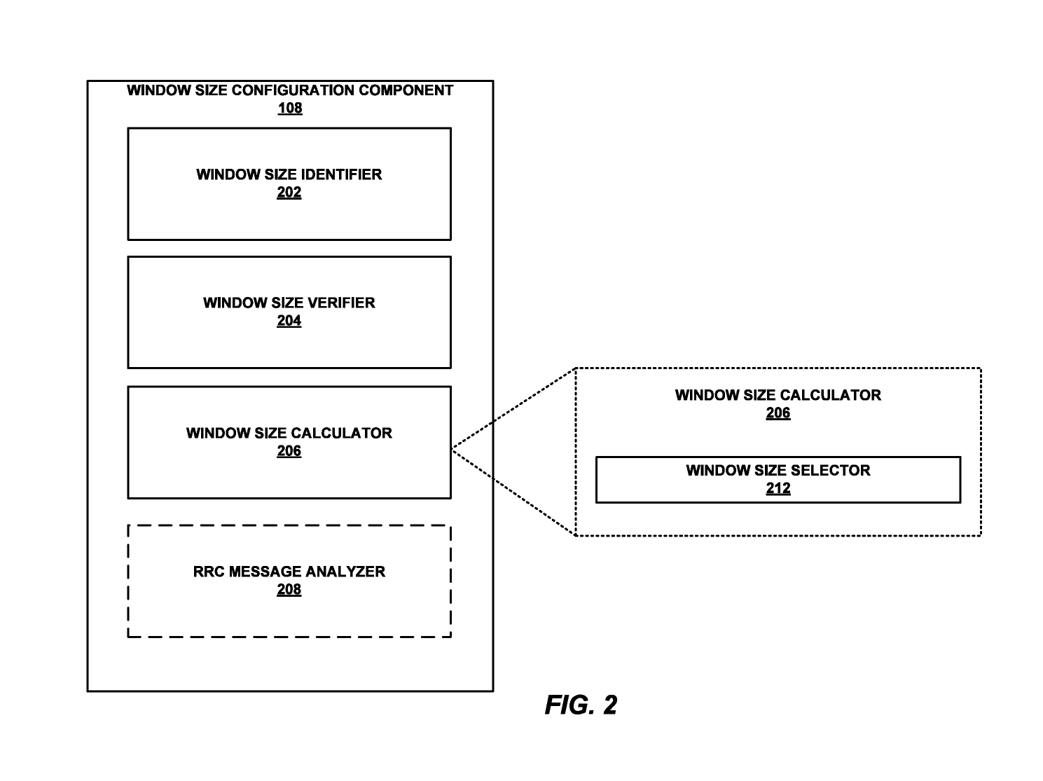

Referring to FIG. 2, components by which the techniques for window size configuration may be implemented are further illustrated in addition to FIG. 1. As illustrated in FIG. 2, dash-lined blocks may indicate optional components of aspects of UE 102.

As depicted, window size configuration component 108 may, at least include, a window size identifier 202 configured to identify a MAC-ehs window size previously or currently used for communications between UE 102 and source network 104. In addition, window size identifier 202 may store the identified MAC-ehs window size previously used for the communications with source network 104 in a memory device (not shown) associated with UE 102.

Window size configuration component 108 may further include a window size verifier 204 that may be configured to determine that the identified MAC-ehs window size is invalid for the target configuration of communications between UE 102 and target network 106. That is, window size verifier 204 may, for example, detect a number of carriers that target network 106 supports. Based on the detected number of carriers, window size verifier 204 may determine a maximum valid MAC-ehs window size of the target configuration since the correspondence between the number of carriers and the maximum valid MAC-ehs window size may be specified in communications standards. For example, when window size verifier 204 detects that target network 106 supports DC, window size verifier 204 may determine that the maximum valid MAC-ehs window size is 32 per 3GPP 25.331 10.3.5.1c.

In addition, window size configuration component 108 may include a window size calculator 206 that may be configured to calculate another or different MAC-ehs window size to be used for the target configuration when a determination is made that the identified MAC-ehs window size is invalid for the target configuration. Such calculation may be performed by window size calculator 206 based on one or more parameters associated with target network 106 including a maximum window size supported by the target configuration. In some aspects, the one or more parameters may also include a stored MAC-ehs window size from a previous configuration of the communications between UE 102 and source network 104.

Further, window size calculator 206 may include, as illustrated by the dotted-line expansion of window size calculator 206, and a window size selector 212, interacting with an RRC message analyzer 208, for such calculation, which may be performed based on the RRC messages that UE 102 receives to reconfigure UE 102. That is, RRC message analyzer 208 may determine the type of RRC message received by UE 102 and whether the RRC message includes a MAC-ehs window size for the target configuration. Based on the determination, window size calculator 206 may then calculate the MAC-ehs window size for the target configuration.

For example, if the RRC message received by UE 102, e.g., a RBRC or TCRC message, to reconfigure UE 102 omits or otherwise does not provide a MAC-ehs window size, or the RRC message is a PCRC message that typically does not include a MAC-ehs window size, window size selector 212 may be configured to select a smallest window size from the stored MAC-ehs window size from the previous configuration and the maximum window size supported by the target configuration. Further to the example, when the maximum window size supported by target network 106 is 32 and the stored MAC-ehs window size from the previous configuration is 64 for the previous communications between UE 102 and target network 106, window size selector 212 may select 32 as the MAC-ehs window size for the target configuration.

Alternatively, if a PCRC message is received by UE 102 for the target configuration and the stored MAC-ehs window size from the previous configuration is not supported in the target configuration, UE 102 may be configured to reject the configuration. That is, in a non-limiting example, UE 102 may be configured to send a failure message to target network 106 to indicate the invalidity of the stored MAC-ehs window size in the target configuration. UE 102 may then revert to source network 104 to continue the communications with source network 104 with the stored MAC-ehs window size from the previous configuration. In another example, if a RBRC message or a TCRC message received by the UE for the target configuration omits a value indicating a MAC-ehs window size, UE 102 may also be configured to reject the configuration.

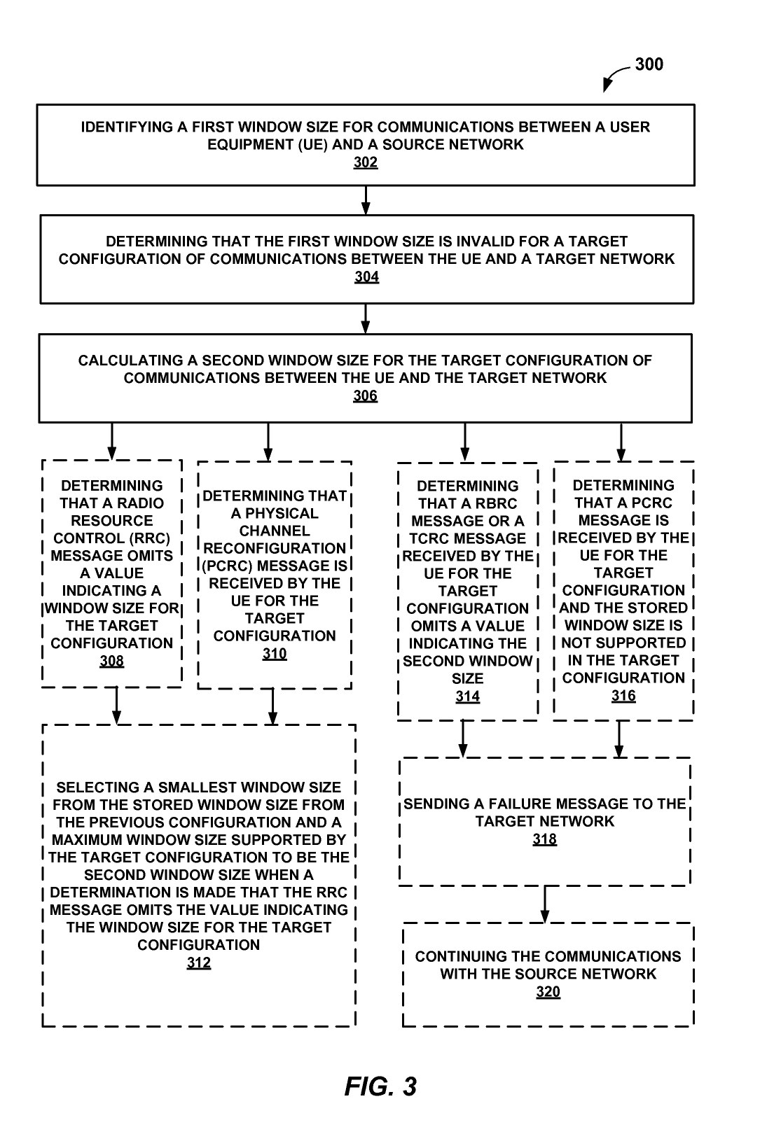

Referring to FIG. 3, aspects of a method 300 for configuring a window size may be performed by UE 102 of FIG. 1. In an aspect, UE 102 may perform aspects of method 300 when operating according to SC, DC, or MC HSDPA. More particularly, aspects of method 300 may be performed by window size configuration component 108 that includes window size manager 202, window size verifier 204, window size calculator 206, RRC message analyzer 208, and window size selector 212 as shown in FIG. 2. As illustrated in FIG. 3, dash-lined blocks may indicate optional operations of aspects of method 300.

At 302, method 300 includes identifying a first window size for communications between a UE and a source network. For example, window size identifier 202 may be configured to identify as the first window size a MAC-ehs window size previously used for communications between UE 102 and source network 104.

At 304, method 300 includes determining that the first window size is invalid for a target configuration of communications between the UE and a target network. For example, window size verifier 204 may be configured to determine that the identified MAC-ehs window size is invalid for the target configuration of communications between UE 102 and target network 106. That is, window size verifier 204 may detect the number of carriers that target network 106 supports. Based on the detected number of carriers, window size verifier 204 may determine the maximum valid MAC-ehs window size of the target configuration since the correspondence between the number of carriers and the maximum valid MAC-ehs window size may be specified in communication standards. For example, when window size verifier 204 detects that target network 106 supports DC, window size verifier 204 may determine that the maximum valid MAC-ehs window size is 32 per 3GPP 25.331 10.3.5.1c.

At 306, method 300 includes calculating a second window size for the target configuration of communications between the UE and the target network. For example, window size calculator 206 may be configured to calculate as the second window size another MAC-ehs window size for the target configuration when a determination is made that the identified MAC-ehs window size is invalid for the target configuration. Such calculation may be performed by window size calculator 206 based on one or more parameters associated with target network 106 including a maximum window size supported by the target configuration. In some aspects, the parameters may also include a stored MAC-ehs window size from a previous configuration of the communications between UE 102 and source network 104. Further, window size calculator 206 may include window size selector 212, interacting with RRC message analyzer 208, for such calculation, which may be performed based on the RRC messages that UE 102 receives to reconfigure UE 102.

At 308, method 300 includes determining that RRC message omits a value indicating a window size for the target configuration. That is, RRC message analyzer 208 may be configured to determine that the RRC message received by UE 102, e.g., a RBRC or TCRC message, to reconfigure UE 102 does not include or indicate a MAC-ehs window size.

At 310, method 300 includes determining that a PCRC message is received by the UE for the target configuration. That is, RRC message analyzer 208 may be configured to determine that the RRC message received by UE 102 is a PCRC message that typically does not include or indicate a MAC-ehs window size.

At 312, method 300 includes selecting a smallest window size from the stored window size from the previous configuration and a maximum window size supported by the target configuration to be the second window size when a determination is made that the RRC message omits the value indicating the window size for the target configuration. That is, if RRC message analyzer 208 determines that the RRC message received by UE 102, e.g., a RBRC or TCRC message, omits a MAC-ehs window size or the RRC message is a PCRC message, window size selector 212 may be configured to select a smallest window size from the stored MAC-ehs window size from the previous configuration and the maximum window size supported by the target configuration.

At 314, method 300 includes determining that a RBRC message or a TCRC message received by the UE for the target configuration omits a value indicating the second window size. For example, RRC message analyzer 208 may be configured to determine if a RBRC message or a TCRC message received by the UE for the target configuration does not indicate a MAC-ehs window size.

At 316, method 300 includes determining that a PCRC message is received by the UE for the target configuration and the stored window size is not supported in the target configuration. For example, RRC message analyzer 208 may be configured to determine if a PCRC message is received by UE 102 for the target configuration and the stored MAC-ehs window size from the previous configuration is not supported in the target configuration.

At 318, method 300 includes sending a failure message to the target network when a determination is made that the RBRC message or the TCRC message omits the value indicating the window size for the target configuration. That is, UE 102 may be configured to send a failure message to target network 106 to indicate the invalidity of the stored MAC-ehs window size in the target configuration.

At 320, method 300 includes continuing the communications with the source network. That is, UE 102 may then revert to source network 104 to continue the communications with source network 104 with the stored MAC-ehs window size from the previous configuration.

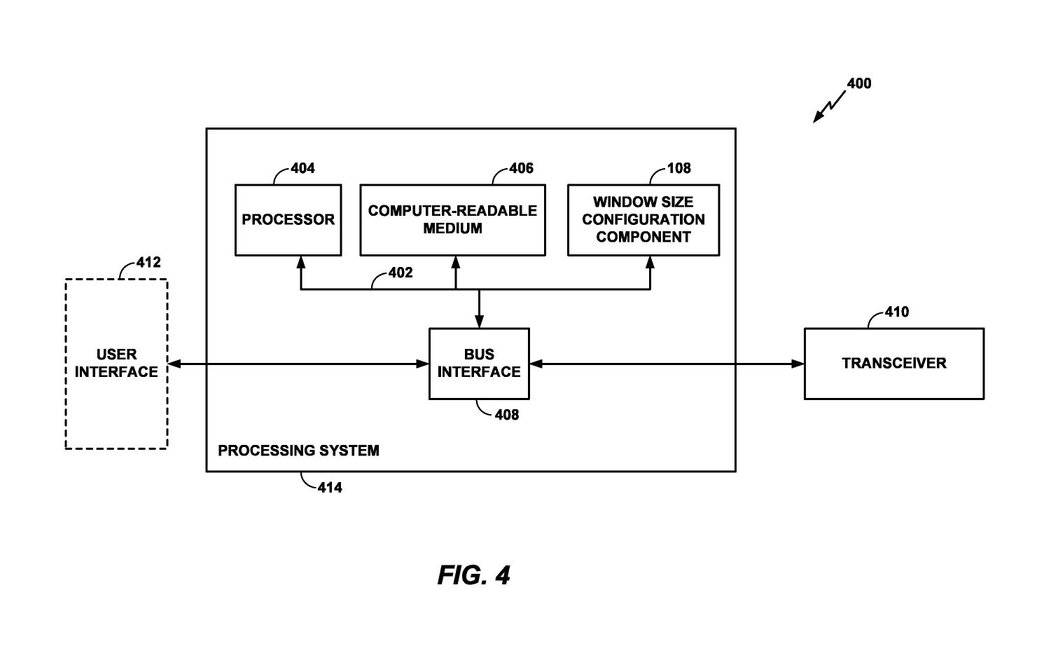

Referring to FIG. 4, an example of a hardware implementation for an apparatus 400 employing a processing system 414 having aspects configured to configure a window size. In an aspect, apparatus 400 may be UE 102 of FIG. 1, including window size configuration component 108.

In this example, the processing system 414 may be implemented with a bus architecture, represented generally by the bus 402. The bus 402 may include any number of interconnecting buses and bridges depending on the specific application of the processing system 414 and the overall design constraints. The bus 402 links together various circuits including one or more processors, represented generally by the processor 404, one or more communications components, such as, for example, window size configuration component 108 of FIG. 1, and computer-readable media, represented generally by the computer-readable medium 406. The bus 402 may also link various other circuits such as timing sources, peripherals, voltage regulators, and power management circuits, which are well known in the art, and therefore, will not be described any further. A bus interface 408 provides an interface between the bus 402 and a transceiver 410. The transceiver 410 provides a means for communicating with various other apparatus over a transmission medium. Depending upon the nature of the apparatus, a user interface 412 (e.g., keypad, display, speaker, microphone, joystick) may also be provided.

The processor 404 is responsible for managing the bus 402 and general processing, including the execution of software stored on the computer-readable medium 406. The software, when executed by the processor 404, causes the processing system 414 to perform the various functions described herein for any particular apparatus. More particularly, and as described above with respect to FIG. 1, window size configuration component 108 may be software components (e.g., software modules), such that the functionality described with respect to each of the modules may be performed by processor 404.

The computer-readable medium 406 may also be used for storing data that is manipulated by the processor 404 when executing software, such as, for example, software modules represented by window size configuration component 108.

In one example, the software modules (e.g., any algorithms or functions that may be executed by processor 404 to perform the described functionality) and/or data used therewith (e.g., inputs, parameters, variables, and/or the like) may be retrieved from computer-readable medium 406.

More particularly, the processing system further includes window size configuration component 108. The various components or functionalities provided by window size configuration component 108 as illustrated in FIG. 2 may be performed by software modules running in the processor 404, resident and/or stored in the computer-readable medium 406, one or more hardware modules coupled to the processor 404, or some combination thereof.

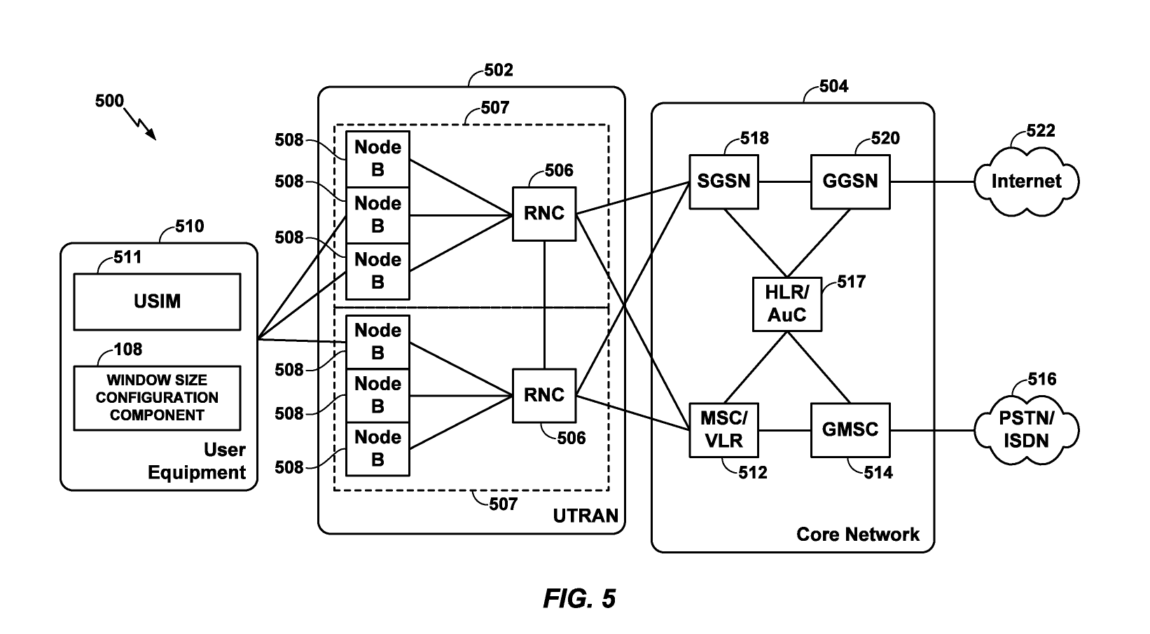

The various concepts presented throughout this disclosure may be implemented across a broad variety of telecommunication systems, network architectures, and communication standards. By way of example and without limitation, the aspects of the present disclosure illustrated in FIG. 5 are presented with reference to a UMTS system 500 employing a W-CDMA air interface and having aspects configured to configure a window size. A UMTS network includes three interacting domains: a Core Network (CN) 504, a UMTS Terrestrial Radio Access Network (UTRAN) 502, and User Equipment (UE) 510. In an aspect, UE 510 may be an example of UE 102 of FIG. 1, including window size configuration component 108. In this example, the UTRAN 502 provides various wireless services including telephony, video, data, messaging, broadcasts, and/or other services. The UTRAN 502 may include a plurality of Radio Network Subsystems (RNSs) such as an RNS 507, each controlled by a respective Radio Network Controller (RNC) such as an RNC 506. Here, the UTRAN 502 may include any number of RNCs 506 and RNSs 507 in addition to the RNCs 506 and RNSs 507 illustrated herein. The RNC 506 is an apparatus responsible for, among other things, assigning, reconfiguring and releasing radio resources within the RNS 507. The RNC 506 may be interconnected to other RNCs (not shown) in the UTRAN 502 through various types of interfaces such as a direct physical connection, a virtual network, or the like, using any suitable transport network.

Communication between a UE 510 and a Node B 508, which may be an example of an entity or component of source network 104 or target network 106 of FIG. 1, may be considered as including a physical (PHY) layer and a medium access control (MAC) layer. Further, communication between a UE 510 and an RNC 506 by way of a respective Node B 508 may be considered as including a radio resource control (RRC) layer. In the instant specification, the PHY layer may be considered layer 1; the MAC layer may be considered layer 2; and the RRC layer may be considered layer 3. Information herein below utilizes terminology introduced in the RRC Protocol Specification, 3GPP TS 25.331 v9.1.0, incorporated herein by reference.

The geographic region covered by the RNS 507 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 508 are shown in each RNS 507; however, the RNSs 507 may include any number of wireless Node Bs. The Node Bs 508 provide wireless access points to a CN 504 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 510 may further include a universal subscriber identity module (USIM) 511, which contains a user's subscription information to a network. For illustrative purposes, one UE 510 is shown in communication with a number of the Node Bs 508. The DL, also called the forward link, refers to the communication link from a Node B 508 to a UE 510, and the UL, also called the reverse link, refers to the communication link from a UE 510 to a Node B 508.

The CN 504 interfaces with one or more access networks, such as the UTRAN 502. As shown, the CN 504 is a GSM core network. However, as those skilled in the art will recognize, the various concepts presented throughout this disclosure may be implemented in a RAN, or other suitable access network, to provide UEs with access to types of CNs other than GSM networks.

The CN 504 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 504 supports circuit-switched services with a MSC 512 and a GMSC 514. In some applications, the GMSC 514 may be referred to as a media gateway (MGW). One or more RNCs, such as the RNC 506, may be connected to the MSC 512. The MSC 512 is an apparatus that controls call setup, call routing, and UE mobility functions. The MSC 512 also includes a VLR that contains subscriber-related information for the duration that a UE is in the coverage area of the MSC 512. The GMSC 514 provides a gateway through the MSC 512 for the UE to access a circuit-switched network 516. The GMSC 514 includes a home location register (HLR) 515 containing subscriber data, such as the data reflecting the details of the services to which a particular user has subscribed. The HLR is also associated with an authentication center (AuC) that contains subscriber-specific authentication data. When a call is received for a particular UE, the GMSC 514 queries the HLR 515 to determine the UE's location and forwards the call to the particular MSC serving that location.

The CN 504 also supports packet-data services with a serving GPRS support node (SGSN) 518 and a gateway GPRS support node (GGSN) 520. GPRS, which stands for General Packet Radio Service, is designed to provide packet-data services at speeds higher than those available with standard circuit-switched data services. The GGSN 520 provides a connection for the UTRAN 502 to a packet-based network 522. The packet-based network 522 may be the Internet, a private data network, or some other suitable packet-based network. The primary function of the GGSN 520 is to provide the UEs 510 with packet-based network connectivity. Data packets may be transferred between the GGSN 520 and the UEs 510 through the SGSN 518, which performs primarily the same functions in the packet-based domain as the MSC 512 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 508 and a UE 510. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 510 provides feedback to the Node B 508 over the HS-DPCCH to indicate whether it correctly decoded a packet on the downlink.

HS-DPCCH further includes feedback signaling from the UE 510 to assist the Node B 508 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the Node B 508 and/or the UE 510 may have multiple antennas supporting MIMO technology. The use of MIMO technology enables the Node B 508 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 510 to increase the data rate or to multiple UEs 510 to increase the overall system capacity. This is achieved by spatially precoding each data stream and then transmitting each spatially precoded stream through a different transmit antenna on the downlink. The spatially precoded data streams arrive at the UE(s) 510 with different spatial signatures, which enables each of the UE(s) 510 to recover the one or more the data streams destined for that UE 510. On the uplink, each UE 510 may transmit one or more spatially precoded data streams, which enables the Node B 508 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

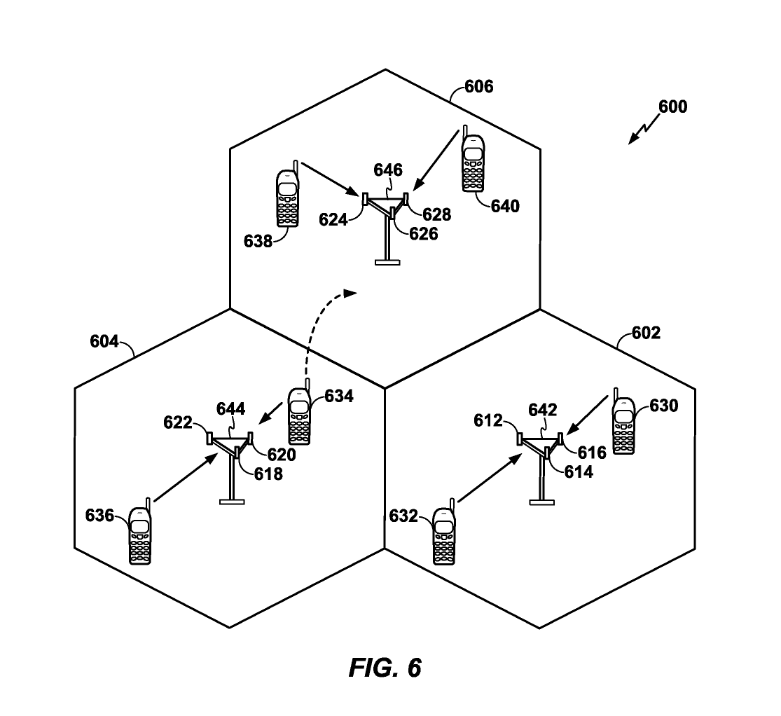

Referring to FIG. 6, an access network 600 is in a UTRAN architecture having aspects configured to configure a window size. The multiple access wireless communication system includes multiple cellular regions (cells), including cells 602, 604, and 606, each of which may include one or more sectors. The multiple sectors can be formed by groups of antennas with each antenna responsible for communication with UEs in a portion of the cell. For example, in cell 602, antenna groups 612, 614, and 616 may each correspond to a different sector. In cell 604, antenna groups 618, 620, and 622 each correspond to a different sector. In cell 606, antenna groups 624, 626, and 628 each correspond to a different sector. The cells 602, 604 and 606 may include several wireless communication devices, e.g., User Equipment or UEs, which may be in communication with one or more sectors of each cell 602, 604 or 606. For example, UEs 630 and 632 may be in communication with Node B 642, UEs 634 and 636 may be in communication with Node B 644, and UEs 638 and 640 can be in communication with Node B 646. In an aspect, one of UEs 630, 632, 634, 636, 638, and/or 640 may be an example of UE 102 of FIG. 1. Here, each Node B 642, 644, and 646 is configured to provide an access point to a CN 504 (see FIG. 5) for all the UEs 630, 632, 634, 636, 638, 640 in the respective cells 602, 604, and 606. In an aspect, Node Bs 642, 644, and 646 may be examples of Node Bs associated with source network 104 and/or target network 106 of FIG. 1.

As the UE 634 moves from the illustrated location in cell 604 into cell 606, a serving cell change (SCC) or handover may occur in which communication with the UE 634 transitions from the cell 604, which may be referred to as the source cell, to cell 606, which may be referred to as the target cell. Management of the handover procedure may take place at the UE 634, at the Node Bs corresponding to the respective cells, at a radio network controller 506 (see FIG. 5), or at another suitable node in the wireless network. For example, during a call with the source cell 604, or at any other time, the UE 634 may monitor various parameters of the source cell 604 as well as various parameters of neighboring cells such as cells 606 and 602. Further, depending on the quality of these parameters, the UE 634 may maintain communication with one or more of the neighboring cells. During this time, the UE 634 may maintain an Active Set, that is, a list of cells that the UE 634 is simultaneously connected to (i.e., the UTRA cells that are currently assigning a downlink dedicated physical channel DPCH or fractional downlink dedicated physical channel F-DPCH to the UE 634 may constitute the Active Set).

The modulation and multiple access scheme employed by the access network 600 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

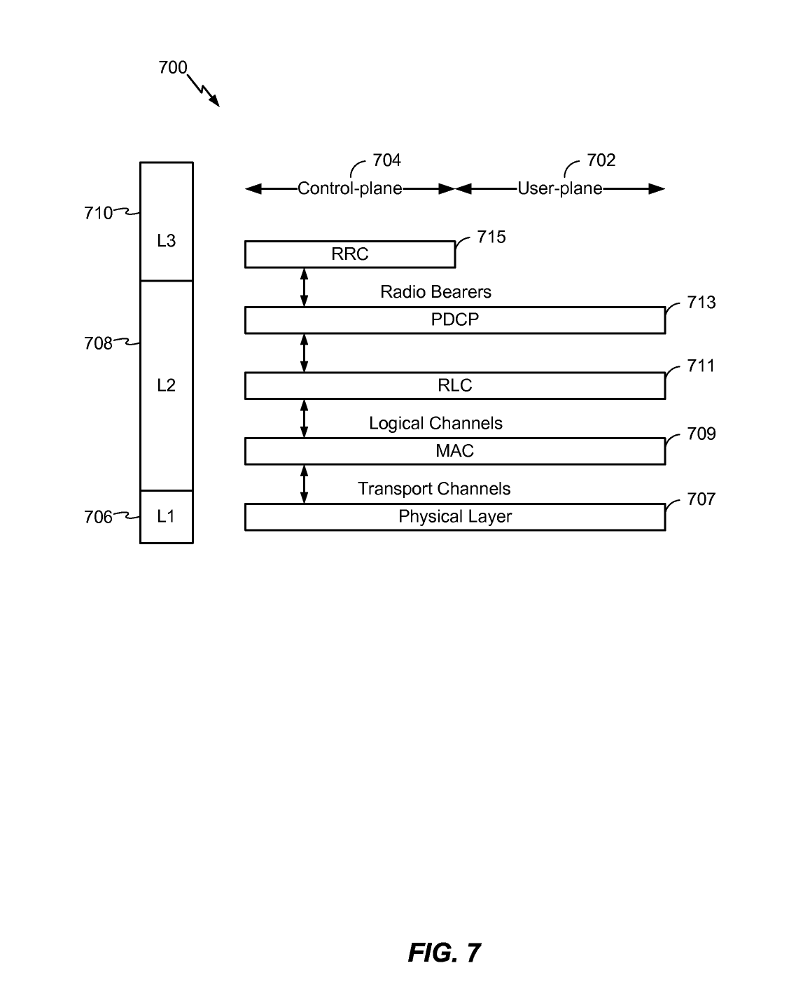

The radio protocol architecture may take on various forms depending on the particular application. An example for an HSPA system will now be presented with reference to FIG. 7.

Referring to FIG. 7, an example radio protocol architecture 700 relates to the user plane 702 and the control plane 704 of a user equipment (UE) or Node B/base station in communication with one another and having aspects configured to configure a window size. In an aspect, architecture 700 may be included in a UE such as UE 102 of FIG. 1 having window size configuration component 108. In an aspect, architecture 700 may be included in a base station, such as base stations associated with source network 104 or target network 106 of FIG. 1. The radio protocol architecture 700 for the UE and Node B is shown with three layers: Layer 1 706, Layer 2 708, and Layer 3 710. Layer 1 706 is the lowest lower and implements various physical layer signal processing functions. As such, Layer 1 706 includes the physical layer 707. Layer 2 (L2 layer) 708 is above the physical layer 707 and is responsible for the link between the UE and Node B over the physical layer 707. Layer 3 (L3 layer) 710 includes a radio resource control (RRC) sublayer 715. The RRC sublayer 715 handles the control plane signaling of Layer 3 between the UE and the UTRAN.

In the user plane, the L2 layer 708 includes a media access control (MAC) sublayer 709, a radio link control (RLC) sublayer 711, and a packet data convergence protocol (PDCP) 713 sublayer, which are terminated at the Node B on the network side. Although not shown, the UE may have several upper layers above the L2 layer 708 including a network layer (e.g., IP layer) that is terminated at a PDN gateway on the network side, and an application layer that is terminated at the other end of the connection (e.g., far end UE, server, etc.).

The PDCP sublayer 713 provides multiplexing between different radio bearers and logical channels. The PDCP sublayer 713 also provides header compression for upper layer data packets to reduce radio transmission overhead, security by ciphering the data packets, and handover support for UEs between Node Bs. The RLC sublayer 711 provides segmentation and reassembly of upper layer data packets, retransmission of lost data packets, and reordering of data packets to compensate for out-of-order reception due to hybrid automatic repeat request (HARQ). The MAC sublayer 709 provides multiplexing between logical and transport channels. The MAC sublayer 709 is also responsible for allocating the various radio resources (e.g., resource blocks) in one cell among the UEs. The MAC sublayer 709 is also responsible for HARQ operations.

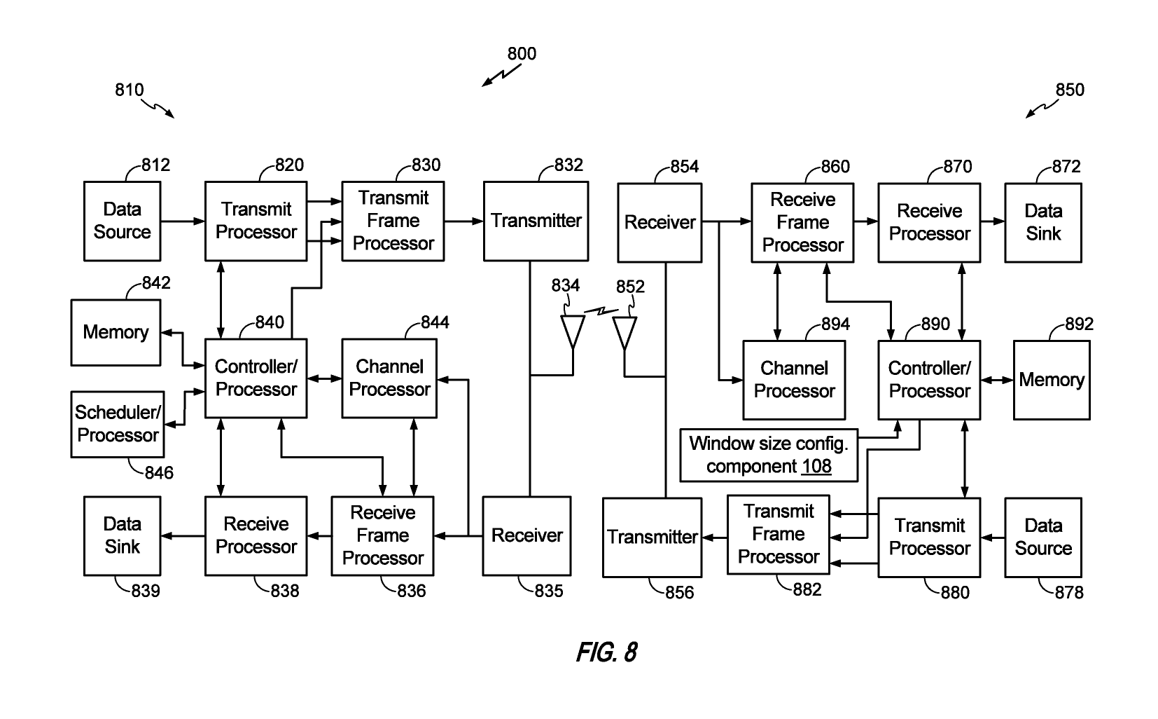

Referring to FIG. 8, a Node B 810 is in communication with a UE 850 and having aspects configured to configure a window size. In an aspect, the Node B 810 may be an example component of source network 104 or target network 106 of FIG. 1. In an aspect, the UE 850 may be an example of UE 102 of FIG. 1 having window size configuration component 108 (referred to as window size config. component 108 in FIG. 8). In the downlink communication, a transmit processor 820 may receive data from a data source 812 and control signals from a controller/processor 840. The transmit processor 820 provides various signal processing functions for the data and control signals, as well as reference signals (e.g., pilot signals). For example, the transmit processor 820 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 844 may be used by a controller/processor 840 to determine the coding, modulation, spreading, and/or scrambling schemes for the transmit processor 820. These channel estimates may be derived from a reference signal transmitted by the UE 850 or from feedback from the UE 850. The symbols generated by the transmit processor 820 are provided to a transmit frame processor 830 to create a frame structure. The transmit frame processor 830 creates this frame structure by multiplexing the symbols with information from the controller/processor 840, resulting in a series of frames. The frames are then provided to a transmitter 832, which provides various signal conditioning functions including amplifying, filtering, and modulating the frames onto a carrier for downlink transmission over the wireless medium through antenna 834. The antenna 834 may include one or more antennas, for example, including beam steering bidirectional adaptive antenna arrays or other similar beam technologies.

At the UE 850, a receiver 854 receives the downlink transmission through an antenna 852 and processes the transmission to recover the information modulated onto the carrier. The information recovered by the receiver 854 is provided to a receive frame processor 860, which parses each frame, and provides information from the frames to a channel processor 894 and the data, control, and reference signals to a receive processor 870. The receive processor 870 then performs the inverse of the processing performed by the transmit processor 820 in the Node B 810. More specifically, the receive processor 870 descrambles and despreads the symbols, and then determines the most likely signal constellation points transmitted by the Node B 810 based on the modulation scheme. These soft decisions may be based on channel estimates computed by the channel processor 894. The soft decisions are then decoded and deinterleaved to recover the data, control, and reference signals. The CRC codes are then checked to determine whether the frames were successfully decoded. The data carried by the successfully decoded frames will then be provided to a data sink 872, which represents applications running in the UE 850 and/or various user interfaces (e.g., display). Control signals carried by successfully decoded frames will be provided to a controller/processor 890. When frames are unsuccessfully decoded by the receiver processor 870, the controller/processor 890 may also use an acknowledgement (ACK) and/or negative acknowledgement (NACK) protocol to support retransmission requests for those frames.

In the uplink, data from a data source 878 and control signals from the controller/processor 890 are provided to a transmit processor 880. The data source 878 may represent applications running in the UE 850 and various user interfaces (e.g., keyboard). Similar to the functionality described in connection with the downlink transmission by the Node B 810, the transmit processor 880 provides various signal processing functions including CRC codes, coding and interleaving to facilitate FEC, mapping to signal constellations, spreading with OVSFs, and scrambling to produce a series of symbols. Channel estimates, derived by the channel processor 894 from a reference signal transmitted by the Node B 810 or from feedback contained in the midamble transmitted by the Node B 810, may be used to select the appropriate coding, modulation, spreading, and/or scrambling schemes. The symbols produced by the transmit processor 880 will be provided to a transmit frame processor 882 to create a frame structure. The transmit frame processor 882 creates this frame structure by multiplexing the symbols with information from the controller/processor 890, resulting in a series of frames. The frames are then provided to a transmitter 856, which provides various signal conditioning functions including amplification, filtering, and modulating the frames onto a carrier for uplink transmission over the wireless medium through the antenna 852.

The uplink transmission is processed at the Node B 810 in a manner similar to that described in connection with the receiver function at the UE 850. A receiver 835 receives the uplink transmission through the antenna 834 and processes the transmission to recover the information modulated onto the carrier. The information recovered by the receiver 835 is provided to a receive frame processor 836, which parses each frame, and provides information from the frames to the channel processor 844 and the data, control, and reference signals to a receive processor 838. The receive processor 838 performs the inverse of the processing performed by the transmit processor 880 in the UE 850. The data and control signals carried by the successfully decoded frames may then be provided to a data sink 839 and the controller/processor, respectively. If some of the frames were unsuccessfully decoded by the receive processor, the controller/processor 840 may also use an acknowledgement (ACK) and/or negative acknowledgement (NACK) protocol to support retransmission requests for those frames.

The controller/processors 840 and 890 may be used to direct the operation at the Node B 810 and the UE 850, respectively. For example, the controller/processors 840 and 890 may provide various functions including timing, peripheral interfaces, voltage regulation, power management, and other control functions. The computer readable media of memories 842 and 892 may store data and software for the Node B 810 and the UE 850, respectively. A scheduler/processor 846 at the Node B 810 may be used to allocate resources to the UEs and schedule downlink and/or uplink transmissions for the UEs.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Several aspects of a telecommunications system have been presented with reference to a W-CDMA system. As those skilled in the art will readily appreciate, various aspects described throughout this disclosure may be extended to other telecommunication systems, network architectures and communication standards. By way of example, the techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM□, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for configuring a window size, comprising:
identifying a first window size for communications between a user equipment (UE) and a source network;
determining that the first window size is invalid for a target configuration of communications between the UE and a target network; and
calculating a second window size for the target configuration of communications between the UE and the target network,
wherein the calculating is based on one or more parameters of the target configuration when a determination is made that the first window size is invalid in the target configuration, and
wherein the one or more parameters at least include a stored window size from a previous configuration of the communications between the UE and the source network.

2. The method of claim 1, wherein the source network supports more than two carriers and the target network supports one or two carriers.

3. The method of claim 1, further comprising:
determining that a radio resource control (RRC) message omits a value indicating a window size for the target configuration, wherein the calculating the second window size comprises selecting a smallest window size from the stored window size from the previous configuration and a maximum window size supported by the target configuration to be the second window size when a determination is made that the RRC message omits the value indicating the window size for the target configuration.

4. The method of claim 1, further comprising:
determining that a physical channel reconfiguration (PCRC) message is received by the UE for the target configuration, wherein the calculating the second window size comprises selecting a smallest window size from the stored window size from the previous configuration and a maximum window size supported by the target configuration to be the second window size when a determination is made that the RRC message omits the value indicating the window size for the target configuration.

5. The method of claim 3, wherein the RRC message is a PCRC message, a Radio Bearer Reconfiguration (RBRC) message, or a Transport Channel Reconfiguration (TCRC) message.

6. The method of claim 1, further comprising:
determining that a RBRC message or a TCRC message received by the UE for the target configuration omits a value indicating the second window size;
sending a failure message to the target network when a determination is made that the RBRC message or the TCRC message omits the value indicating the window size for the target configuration; and
continuing the communications with the source network.

7. The method of claim 1, further comprising:
determining that a PCRC message is received by the UE for the target configuration and the stored window size is not supported in the target configuration;
sending a failure message to the target network when a determination is made that the PCRC message omits the value indicating the window size for the target configuration; and
continuing the communications with the source network.

8. An apparatus for configuring a window size, comprising:
means for identifying a first window size for communications between a user equipment (UE) and a source network;
means for determining that the first window size is invalid for a target configuration of communications between the UE and a target network; and
means for calculating a second window size for the target configuration of communications between the UE and the target network,
wherein the means for calculating is based on one or more parameters of the target configuration when a determination is made that the first window size is invalid in the target configuration, and
wherein the one or more parameters at least include a stored window size from a previous configuration of the communications between the UE and the source network.

9. The apparatus of claim 8, wherein the source network supports more than two carriers and the target network supports one or two carriers.

10. The apparatus of claim 8, further comprising:
means for determining that a radio resource control (RRC) message omits a value indicating a window size for the target configuration, wherein the means for calculating the second window size comprises selecting a smallest window size from the stored window size from the previous configuration and a maximum window size supported by the target configuration to be the second window size when a determination is made that the RRC message omits the value indicating the window size for the target configuration.

11. The apparatus of claim 8, further comprising:
means for determining that a physical channel reconfiguration (PCRC) message is received by the UE for the target configuration, wherein the means for calculating the second window size comprises selecting a smallest window size from the stored window size from the previous configuration and a maximum window size supported by the target configuration to be the second window size when a determination is made that the RRC message omits the value indicating the window size for the target configuration.

12. The apparatus of claim 10, wherein the RRC message is a PCRC message, a Radio Bearer Reconfiguration (RBRC) message, or a Transport Channel Reconfiguration (TCRC) message.

13. The apparatus of claim 8, further comprising:
means for determining that a RBRC message or a TCRC message received by the UE for the target configuration omits a value indicating the second window size;
means for sending a failure message to the target network when a determination is made that the RBRC message or the TCRC message omits the value indicating the window size for the target configuration; and
means for continuing the communications with the source network.

14. The apparatus of claim 8, further comprising:
means for determining that a PCRC message is received by the UE for the target configuration and the stored window size is not supported in the target configuration;
means for sending a failure message to the target network when a determination is made that the PCRC message omits the value indicating the window size for the target configuration; and
means for continuing the communication with the source network.

15. An apparatus for configuring a window size, comprising:
a window size identifier configured to identify a first window size for communications between a user equipment (UE) and a source network;
a window size verifier configured to determine that the first window size is invalid for a target configuration of communications between the UE and a target network; and
a window size calculator configured to calculate a second window size for the target configuration of communications between the UE and the target network,
wherein the window size calculator calculates the second window size based on one or more parameters of the target configuration when a determination is made that the first window size is invalid in the target configuration, and
wherein the one or more parameters at least include a stored window size from a previous configuration of the communications between the UE and the source network.

16. The apparatus of claim 15, wherein the source network supports more than two carriers and the target network supports one or two carriers.

17. The apparatus of claim 15, further comprising:
a radio resource control (RRC) message analyzer configured to determine that a RRC message omits a value indicating a window size for the target configuration, wherein the window size calculator comprises a window size selector configured to select a smallest window size from the stored window size from the previous configuration and a maximum window size supported by the target configuration to be the second window size when a determination is made that the RRC message omits the value indicating the window size for the target configuration.

18. The apparatus of claim 15, further comprising:
an RRC message analyzer configured to determine that that a physical channel reconfiguration (PCRC) message is received by the UE for the target configuration, wherein the window size calculator comprises a window size selector configured to select a smallest window size from the stored window size from the previous configuration and a maximum window size supported by the target configuration to be the second window size when a determination is made that the RRC message omits the value indicating the window size for the target configuration.

19. The apparatus of claim 17, wherein the RRC message is a PCRC message, a Radio Bearer Reconfiguration (RBRC) message, or a Transport Channel Reconfiguration (TCRC) message.

20. The apparatus of claim 15, further comprising:
an RRC message analyzer configured to determine that a RBRC message or a TCRC message received by the UE for the target configuration omits a value indicating the second window size, wherein the UE is configured to
send a failure message to the target network when a determination is made that the RBRC message or the TCRC message omits the value indicating the window size for the target configuration, and
continue the communications with the source network.

21. The apparatus of claim 15, further comprising:
an RRC message analyzer configured to determine that a PCRC message is received by the UE for the target configuration and the stored window size is not supported in the target configuration, wherein the UE is configured to:
send a failure message to the target network when a determination is made that the PCRC message omits the value indicating the window size for the target configuration, and
continue the communications with the source network.

22. A computer-readable medium storing computer executable code for configuring a window size, comprising:
code for identifying a first window size for communications between a user equipment (UE) and a source network;
code for determining that the first window size is invalid for a target configuration of communications between the UE and a target network; and
code for calculating a second window size for the target configuration of communications between the UE and the target network,
wherein the code for calculating is based on one or more parameters of the target configuration when a determination is made that the first window size is invalid in the target configuration, and
wherein the one or more parameters at least include a stored window size from a previous configuration of the communications between the UE and the source network.

23. The computer-readable medium of claim 22, wherein the source network supports more than two carriers and the target network supports one or two carriers.

24. The computer-readable medium of claim 22, further comprising:
code for determining that a radio resource control (RRC) message omits a value indicating a window size for the target configuration, wherein the code for calculating the second window size comprises selecting a smallest window size from the stored window size from the previous configuration and a maximum window size supported by the target configuration to be the second window size when a determination is made that the RRC message omits the value indicating the window size for the target configuration.

25. The computer-readable medium of claim 22, further comprising:
code for determining that a physical channel reconfiguration (PCRC) message is received by the UE for the target configuration, wherein the code for calculating the second window size comprises selecting a smallest window size from the stored window size from the previous configuration and a maximum window size supported by the target configuration to be the second window size when a determination is made that the RRC message omits the value indicating the window size for the target configuration.

26. The computer-readable medium of claim 24, wherein the RRC message is a PCRC message, a Radio Bearer Reconfiguration (RBRC) message, or a Transport Channel Reconfiguration (TCRC) message.

27. The computer-readable medium of claim 22, further comprising:
code for determining that a RBRC message or a TCRC message received by the UE for the target configuration omits a value indicating the second window size;
code for sending a failure message to the target network when a determination is made that the RBRC message or the TCRC message omits the value indicating the window size for the target configuration; and
code for continuing the communications with the source network.

28. The computer-readable medium of claim 22, further comprising:
code for determining that a PCRC message is received by the UE for the target configuration and the stored window size is not supported in the target configuration;
code for sending a failure message to the target network when a determination is made that the PCRC message omits the value indicating the window size for the target configuration; and
code for continuing the communications with the source network.
